(19) United States
(12) Patent Application Publication
(10) Pub. No.: US 2015/0286756 A1
(43) Pub. Date: Oct. 8, 2015

(54) THERMAL FLUID ANALYSIS METHOD, INFORMATION PROCESSING DEVICE, AND RECORDING MEDIUM STORING THERMAL FLUID ANALYSIS PROGRAM

(71) Applicant: FUJITSU LIMITED, Kawasaki-shi (JP)

(72) Inventors: Sachio KOBAYASHI, Sagamihara (JP); Hiroki KOBAYASHI, Kawasaki (JP); Masayoshi HASHIMA, Kawasaki (JP); Yuichi SATO, Yamato (JP); Hiroshi IKEDA, Kawasaki (JP)

(73) Assignee: FUJITSU LIMITED, Kawasaki (JP)

(21) Appl. No.: 14/661,484

(22) Filed: Mar. 18, 2015

(30) Foreign Application Priority Data
Apr. 7, 2014 (JP) 2014-078785

(51) Int. Cl. G06F 17/50; G06F 17/10

(52) U.S. Cl. CPC G06F 17/5009; G06F 17/10

(57) ABSTRACT

A thermal fluid analysis method, includes: calculating, by a computer, a first component of a new first sample different from a plurality of second samples; setting a second component obtained by unitizing the first component to a first base; adding the first base to a plurality of second bases of the plurality of second samples when the first component is greater than a threshold value; and correcting a low-dimensional model that expresses a plurality samples with superposition of a plurality of bases by using the first base and the plurality of second bases.

### CROSS-REFERENCE TO RELATED APPLICATION

This application is based upon and claims the benefit of priority of the prior Japanese Patent Application No. 2014-078785 filed on Apr. 7, 2014, the entire contents of which are incorporated herein by reference.

### FIELD

The embodiments discussed herein are related to a thermal fluid analysis method, an information processing device, and a recording medium that stores a thermal fluid analysis program.

### BACKGROUND

When designing a server apparatus or a data center, a thermal fluid simulation has been used to grasp a heat distribution or an air (fluid) flow in a normal state without using an apparatus that is to be designed. In the thermal fluid simulation, a plurality of time steps which are time-serially continuous are set, and a time series simulation, in which an analysis process of proceeding calculation for each time step is repeated, is performed.

Japanese Laid-open Patent Publication No. 2012-216173 is an example of the related art.

### SUMMARY

According to an aspect of the embodiments, a thermal fluid analysis method, includes: calculating, by a computer, a first component of a new first sample different from a plurality of second samples; setting a second component obtained by unitizing the first component to a first base; adding the first base to a plurality of second bases of the plurality of second samples when the first component is greater than a threshold value; and correcting a low-dimensional model that expresses a plurality samples with superposition of a plurality of bases by using the first base and the plurality of second bases.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of thermal fluid analysis;

FIG. 2 illustrates an example of a configuration of an information processing device;

FIG. 3 illustrates an example of a process in a correction and non-correction determining unit;

FIG. 4 illustrates an example of a low-dimensional model after correction;

FIG. 5 illustrates an example of a low-dimensional model of a flow velocity field after correction;

FIG. 6 illustrates an example of a low-dimensional model of a temperature field after correction;

FIG. 7 illustrates an example of a thermal fluid analysis process;

FIG. 8 illustrates an example of thermal analysis of a data center; and

FIG. 9 illustrates an example of a computer.

### DESCRIPTION OF EMBODIMENTS

For example, in a thermal fluid simulation, a pre-simulation of a flow velocity field and a temperature field is performed. In the pre-simulation, snapshot data (sample) at an arbitrary time step is collected with respect to each of the flow velocity field and the temperature field. Main component analysis is performed with respect to the samples that are collected to acquire an orthogonal base that most efficiently expresses all of the samples, and an undesirable orthogonal base is reduced. For example, in the pre-simulation, time evolution of the flow velocity field and the temperature field is performed by using a incompressive Navier-Stokes equation of the following Equation (1), and a heat equation of the following Equation (2). Navier-Stokes equation may be used.

$$\begin{matrix}\frac{\partial u}{\partial t} = - ( u \cdot ∇ ) u - \frac{1}{ρ} ∇ p + v {∇}^{2} u + f & Equation ( 1 ) \\ \frac{\partial T}{\partial t} = - ( u \cdot ∇ ) T + κ {∇}^{2} T + S & Equation ( 2 )\end{matrix}$$

u represents a velocity vector of a fluid, p represents a pressure, p represents a density, f represents an external force vector that acts per unit mass, v represents a coefficient of kinematic viscosity, T represents a temperature, x represents a coefficient of heat conduction, and S represents an amount of heat received from the outside. Nabla V represents a space differential operator.

For example, in the thermal fluid simulation, an analysis model of the flow velocity field is expressed with superposition of the orthogonal bases which are obtained, and the simulation of the flow velocity field is executed. For example, in the thermal fluid simulation, an analysis model of the temperature field is expressed with superposition of the orthogonal bases which are obtained, and the simulation of the temperature field is executed.

An application range of the analysis model of the thermal fluid simulation is limited to a range of a set of samples. Accordingly, when a new sample increases, time may be taken to recreate a new analysis model. For example, when the sample increases, the pre-simulation is performed in the thermal fluid simulation in a state of including the increased sample. A new analysis model in which the increased sample is also set to the application range is created by using superposition of orthogonal bases which are obtained.

The following examples may be applied to an information processing device that executes the thermal fluid analysis or may be broadly applied to overall devices which execute the thermal fluid analysis.

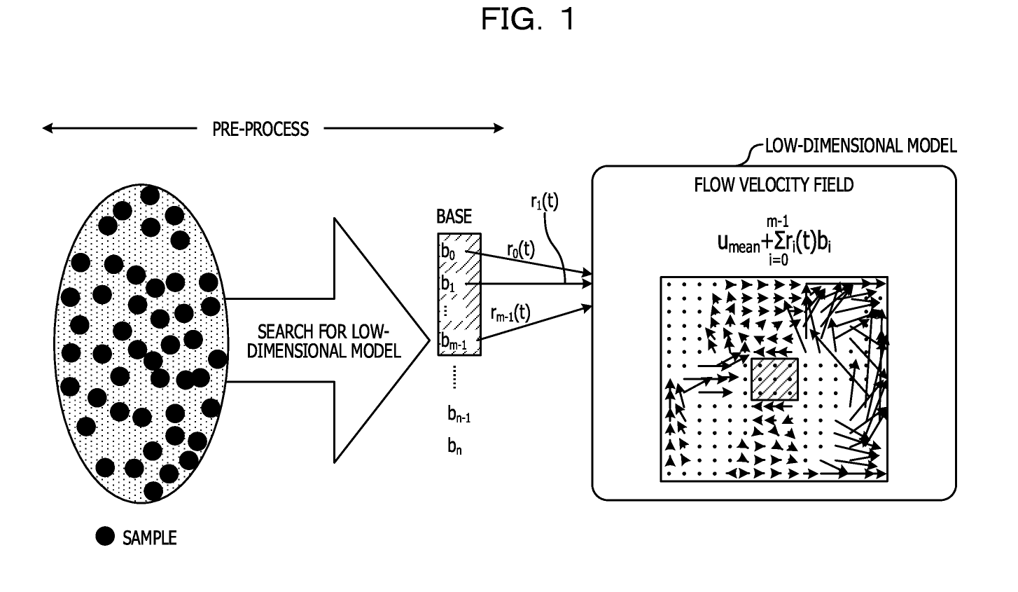

FIG. 1 illustrates an example of the thermal fluid analysis. As illustrated in FIG. 1, in the thermal fluid simulation (also, referred to as “thermal fluid analysis”), for example, the pre-simulation (pre-process) is performed with respect to the flow velocity field. In the pre-process, a snapshot (sample) at an arbitrary time step is collected under various analysis conditions with respect to the flow velocity field. The sample may include a fluid flow velocity that is used in analysis of the flow velocity field, or a temperature distribution that is used in analysis of the temperature field. In the pre-process, a set of samples which are collected is subjected to main-component analysis to acquire an orthogonal base that most efficiently expresses all of the samples. In the pre-process, an undesirable orthogonal base is reduced from orthogonal bases which are acquired. For example, (n-m+1) orthogonal bases which are orthogonal bases bₘ to bₙ are deleted from n+1 orthogonal bases b₀ to bₙ with respect to n+1 analysis conditions, and the remaining orthogonal bases b₀ to bₘ₋₁ are acquired. The remaining orthogonal bases b₀ to bₘ₋₁ may be orthogonal bases which are generated due to a difference between the analysis conditions.

In the thermal fluid analysis, the post-simulation (post-process) is performed with respect to the flow velocity field. In the post-process, an analysis model (low-dimensional model) of the flow velocity field is expressed with superposition of the orthogonal bases which are obtained in the pre-process. For example, the low-dimensional model of the flow velocity field is expressed with superposition of the mean uₘₑₐₙ of samples and m orthogonal bases b₀ to bₘ₋₁ which are generated due to a difference between analysis conditions. Each of r₀(t) to rₘ₋₁(t) represents the magnitude of a component of each sample at an arbitrary point of time t. Accordingly, in the thermal fluid analysis, a flow velocity field at an arbitrary point of time t is simulated. For example, in the thermal fluid analysis, all samples of the flow velocity field at an arbitrary point of time t are expressed. For example, as an analysis result, a flow velocity field at an arbitrary point of time that is an analysis target is expressed. Arrows represent air flows.

In the thermal fluid analysis, as is the case with the flow velocity field, a low-dimensional model of the temperature field is expressed with superposition of orthogonal bases which are obtained in a pre-process corresponding to the temperature field. As a method of creating the low-dimensional model, a method that is disclosed in Japanese Laid-open Patent Publication No. 2012-216173 and the like may be used.

For example, when a new sample increases due to a new analysis condition, in the thermal fluid analysis, the new sample is not expressed by an existing low-dimensional model, and thus a new low-dimensional model is recreated. For example, in the thermal fluid analysis, a pre-process and a post-process are performed by adding a new sample to existing samples, and the low-dimensional model is corrected in order for the new sample to be set to an application range. Time may be taken to recreate a new low-dimensional model.

For example, an information processing device, which corrects the low-dimensional model by only data processing with respect to a new sample, may be provided.

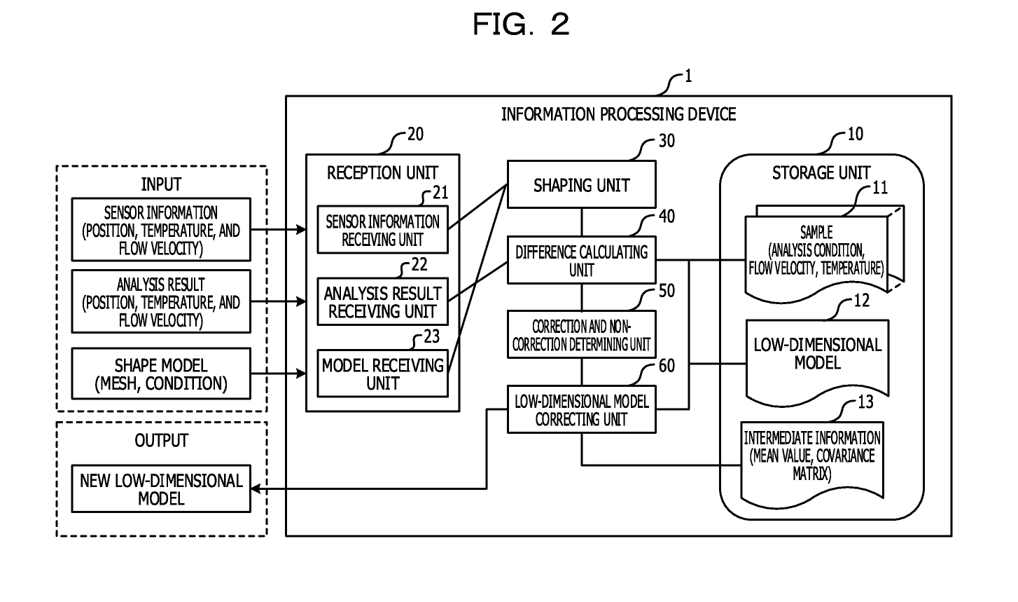

FIG. 2 illustrates an example of a configuration of an information processing device. In FIG. 2, a functional block of the information processing device is illustrated. An information processing device 1 illustrated in FIG. 2 corrects the low-dimensional model, which is used when performing simulation of the flow velocity field and the temperature field, in a case where a new sample is added. As illustrated in FIG. 2, the information processing device 1 includes a storage unit 10, a reception unit 20, a shaping unit 30, a difference calculating unit 40, a correction and non-correction determining unit 50, and a low-dimensional model correcting unit 60.

For example, when changing a layout of a server apparatus in a data center or changing a setting of an air conditioner, the information processing device 1 performs the thermal fluid simulation before actual operation, and executes a power-saving operation of the data center. For example, the information processing device 1 executes the thermal fluid analysis by setting a region in which the server apparatus or the air conditioner is provided as an analysis target. The analysis target may be a region in which the server apparatus or the air conditioner is provided, or a space which is desired to grasp a heat distribution and air flows.

The storage unit 10 stores a sample 11, a low-dimensional model 12, and intermediate information 13. For example, the storage unit 10 may be a semiconductor memory element such as a random access memory (RAM) and a flash memory, or a storage device such as a hard disk and an optical disc.

The sample 11 may be a sample that is used when the low-dimensional model 12 is created. A plurality of the samples 11 may exist. The sample 11 may be snapshot data of each of the flow velocity field and the temperature field which are used when the existing low-dimensional model 12 is created. The sample 11 may be a snapshot of the flow velocity field and the temperature field which correspond to various analysis conditions at each point of time, and may include analysis conditions, a flow velocity, or a temperature. The analysis conditions may be conditions when performing the thermal fluid analysis, and may include, for example, a shape model that is used in the thermal fluid analysis, physical properties, heat generation conditions, convergence conditions, resistance conditions, or fluid feeding conditions. As an example, the analysis conditions may include blowing strength or a setting temperature of an air blower.

The low-dimensional model 12 may be a low-dimensional model that is created by using the samples 11 which are stored in advance. The intermediate information 13 may be various pieces of intermediate information which are desirable for correction of the low-dimensional model 12. For example, the mean value of the samples 11 or a covariance matrix may be included in the intermediate information 13. The mean value of the samples 11 may include the mean value of flow velocities (velocity vectors of a fluid) of the samples 11 or the mean value of temperatures (temperature vectors of the fluid) of the samples 11. The mean value of the flow velocities of the samples 11 is used when correcting the low-dimensional model of the flow velocity field. The mean value of the temperatures of the samples 11 is used when correcting the low-dimensional model of the temperature field.

The reception unit 20 includes a sensor information receiving unit 21, an analysis result receiving unit 22, and a model receiving unit 23. The model receiving unit 23 receives information regarding a shape model in which an analysis target is three-dimensionally modeled or analysis conditions of a new sample, for example, from an external device of the information processing device 1. For example, the external device may be a removable disk or a hard disk drive (HDD). The external device may be coupled to the information processing device 1 through a network or may not be coupled to the information processing device 1. The shape model-related information may include, for example, a shape model that is used in the thermal fluid analysis, a plurality of pieces of mesh information including the shape model, or characteristics of the air blower.

The sensor information receiving unit 21 receives sensor information with respect to a new sample from each sensor. The sensor information may be discrete numerical data in an analysis target space, or a measured value such as a spatial distribution with respect to a temperature and air flows is reproduced. For example, the sensor information may be information in which a new sample is not expressed as a type of an analysis result. The sensor information may include information corresponding to analysis conditions during measurement of each sensor. For example, the sensor information may include a position in an analysis target of each sensor, a temperature or a flow velocity value which is detected by the each sensor, and analysis conditions during measurement.

The analysis result receiving unit 22 receives information, in which a new sample is expressed with a type of an analysis result, from an external device of the information processing device 1. For example, the external device may be a removable disk, or a HDD. The external device may be coupled to the information processing device 1 through a network, or may not be coupled to the information processing device 1. The analysis result may include a position, a temperature, a flow velocity distribution, or analysis conditions. The position represents a position of a mesh in a shape model in which an analysis target is modeled. For example, the temperature and the flow velocity distribution represent a temperature and a flow velocity value distribution which correspond to a position at an arbitrary point of time. For example, the analysis conditions represent analysis conditions which correspond to a position at that point of time.

The shaping unit 30 shapes sensor information with respect to a new sample into the same type as that of the analysis result. For example, the shaping unit 30 calculates a flow velocity value or a temperature at each mesh of the shape model based on the sensor information, which is received by the sensor information receiving unit 21, with respect to the new sample, and reproduces a spatial distribution of an analysis target. For example, the shaping unit 30 may reproduce the spatial distribution from discrete data in a space by using a least-square method, or may reproduce the spatial distribution from discrete data in the space by using a technology in the related art. For example, space interpolation such as smoothing spline or polynomial regression may be used.

The difference calculating unit 40 calculates a difference between a new sample and the existing low-dimensional model 12. For example, the difference calculating unit 40 acquires a new sample that is expressed by an analysis result received by the analysis result receiving unit 22, or a new sample that is shaped by the shaping unit 30. The difference calculating unit 40 calculates a difference between a flow velocity value of the new sample, and the mean value of flow velocities of the samples 11 which are included in the intermediate information 13 by using the following Equation (3) and Equation (4). uₛₙₐₚₛₕₒₜ represents a flow velocity value of a snapshot that is a new sample. uₘₑₐₙ represents the mean value of flow velocities of the samples 11 for each mesh. m represents the number of orthogonal bases of the existing low-dimensional model 12. u_{diff} represents a component of the snapshot which is a new sample.

$$\begin{matrix}\hat{u} = {u}_{snapshot} - {u}_{mean} & Equation ( 3 ) \\ {u}_{diff} = \hat{u} - {\sum }_{i = 0}^{m - 1} ( \hat{u} \cdot {b}_{i} ) {b}_{i} & Equation ( 4 )\end{matrix}$$

The difference calculating unit 40 calculates the magnitude of the calculated difference as the component of the new sample by using the following Equation (5). E represents a component of a snapshot that is a new sample.

E=∥u_{diff}∥ Equation (5)

The correction and non-correction determining unit 50 determines whether or not the magnitude of the component of the new sample is greater than a threshold value that is determined in advance. For example, the correction and non-correction determining unit 50 determines whether or not the new sample is in the application range of the existing low-dimensional model 12. In a case where the component of the new sample is greater than the threshold value, the correction and non-correction determining unit 50 determines that correction of the existing low-dimensional model 12 is desirable. For example, the correction and non-correction determining unit 50 may determine that the new sample may not be expressed with the existing low-dimensional model 12. In a case where the component of the new sample is equal to or less than the threshold value, the correction and non-correction determining unit 50 determines that correction of the existing low-dimensional model 12 may not be desirable. For example, the correction and non-correction determining unit 50 may determine that the new sample is in the application range of the existing low-dimensional model 12.

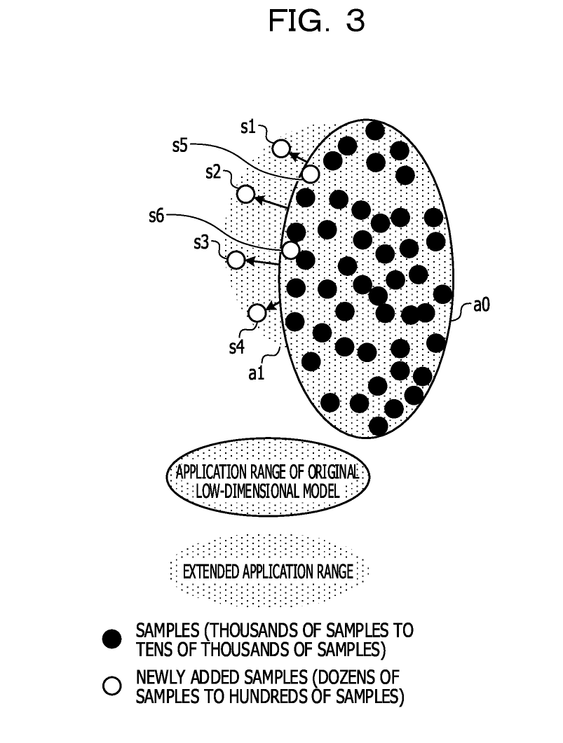

FIG. 3 illustrates an example of a process of a correction and non-correction determining unit. As illustrated in FIG. 3, a plurality of samples 11 are illustrated in an application range a0 of the low-dimensional model 12. For example, the plurality of samples 11 may be expressed with the low-dimensional model 12. The mean value of the flow velocity values of the samples 11 may be positioned, for example, at the center of gravity in the application range a0.

For example, new samples s1 to s6 may be received. The difference calculating unit 40 calculates a difference between a flow velocity value of each of the new samples, and the mean value of the flow velocities of the samples 11, and calculates the calculated difference as a component of the new sample. For example, in FIG. 3, the length of the sample s1 and the mean value of the samples 11 may correspond to a component of the sample s1. The length of the sample s2 and the mean value of the samples 11 may correspond to a component of the sample s2.

The correction and non-correction determining unit 50 determines whether or not the component of the new sample is greater than a threshold value. For example, since the component of the sample s1 is greater than the threshold value, the correction and non-correction determining unit 50 may determine that correction of the low-dimensional model 12 is desirable. For example, the component of the new sample s1 may be determined as a component which is out of the application range of the low-dimensional model 12, and which may not be expressed with the low-dimensional model 12. Similarly, the component of each of the samples s2 to s4 may be determined as a component which is out of the application range of the low-dimensional model 12 and which may not be expressed with the low-dimensional model 12.

Since the component of the sample s5 is equal to or less than the threshold value, the correction and non-correction determining unit 50 determines that correction of the low-dimensional model 12 is not desirable. For example, the component of the new sample s5 is determined as a component which is in the application range of the low-dimensional model 12, and which may be expressed with the low-dimensional model 12. Similarly, the component of the sample s6 is determined as a component which is in the application range of the low-dimensional model 12 and which may be expressed with the low-dimensional model 12.

In FIG. 2, the low-dimensional model correcting unit 60 unitizes a component of a new sample, which is not expressed with the low-dimensional model 12, and newly adds the unitized component as an orthogonal base. The low-dimensional model correcting unit 60 corrects the low-dimensional model 12 by using the newly added orthogonal base and a plurality of orthogonal bases which already exist. The low-dimensional model correcting unit 60 outputs a new low-dimensional model.

For example, in a case where the correction and non-correction determining unit 50 determines that a component of a new sample is greater than the threshold value, the low-dimensional model correcting unit 60 newly adds a vector, which is obtained by unitizing the component of the new sample by using the following Equation (6), as a new orthogonal base. u_{diff} represents a component of a snapshot that is a new sample used in Equation (4) and Equation (5). b_{new} represents a new orthogonal base.

$${b}_{new} = \frac{{u}_{diff}}{‖ {u}_{diff} ‖} \qquad Equation ( 6 )$$

The low-dimensional model correcting unit 60 corrects the low-dimensional model 12 by using the newly added orthogonal base b_{new} and the plurality of orthogonal bases which already exist. When the new orthogonal base is newly added, a component of the new sample which is not expressed with the low-dimensional model 12 before correction becomes equal to or less than the threshold value. The low-dimensional model correcting unit 60 adds the new sample to the storage unit 10, and updates the corrected low-dimensional model 12.

The low-dimensional model correcting unit 60 updates various pieces of intermediate information which are desirable for correction of the new low-dimensional model. For example, the low-dimensional model correcting unit 60 calculates the mean value of the flow velocities of the samples 11 by using the following Equation (7). u_{new} represents a flow velocity value of a new sample.

$${u}_{mean} = \frac{m}{m + 1} {u}_{mean} + \frac{1}{m + 1} {u}_{new} \qquad Equation ( 7 )$$

The low-dimensional model correcting unit 60 sets the mean value of the flow velocities of the calculated samples 11 as the intermediate information 13.

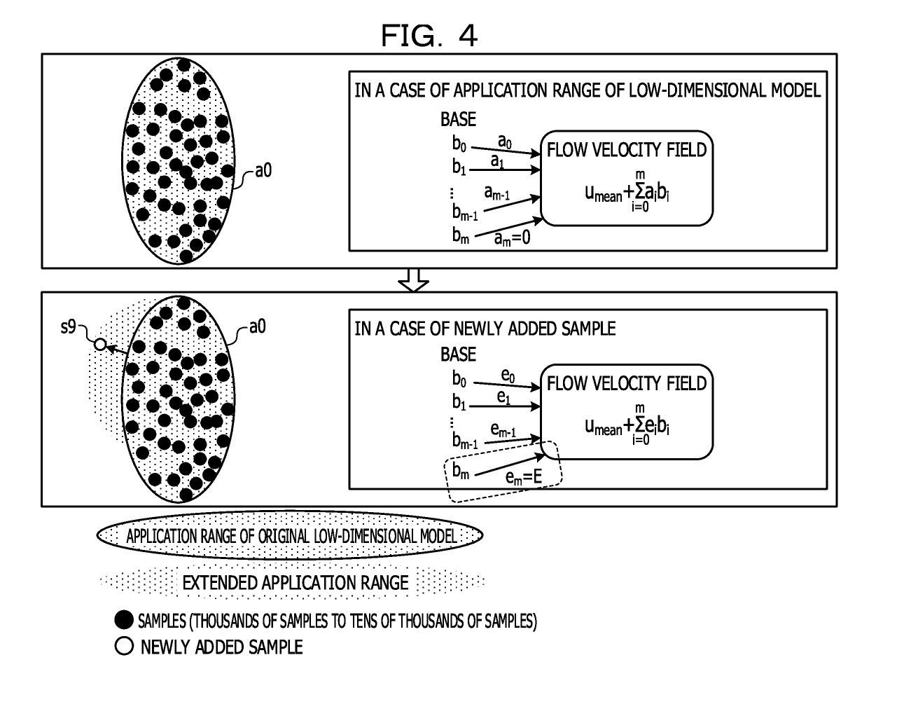

FIG. 4 illustrates an example of a low-dimensional model after correction. In FIG. 4, low-dimensional models before and after correction at an arbitrary point of time are illustrated. In an upper drawing of FIG. 4, the plurality of samples 11 are illustrated in an application range a0 of the original low-dimensional model 12 (before correction). In this case, the low-dimensional model of the flow velocity field may be expressed with superposition of the mean uₘₑₐₙ of the samples, m+1 orthogonal bases b₀ to bₘ which are generated due to a difference between analysis conditions, and magnitudes a₀ to aₘ of components of the respective samples. In a case where a sample corresponding to the orthogonal base bₘ does not exist, the magnitude aₘ of the component of the sample may be set to 0.

For example, a new sample that is not expressed with the low-dimensional model before correction may be added. In a lower drawing of FIG. 4, a new sample s9 is added to the outside of the application range a0 of the original low-dimensional model. In this case, the low-dimensional model of the flow velocity field may be expressed with superposition of the mean uₘₑₐₙ of the samples, m+1 orthogonal bases b₀ to bₘ which are generated due to a difference between analysis conditions, and components e₀ to eₘ of the respective samples. For example, when a sample corresponding to the orthogonal base bₘ is s9, a magnitude eₘ of a component of a sample may be a magnitude E of a component of the sample s9.

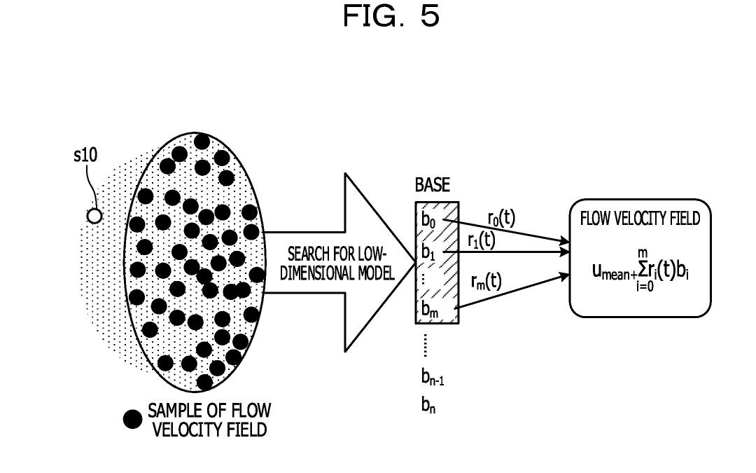

FIG. 5 illustrates an example of a low-dimensional model of a flow velocity field after correction. As illustrated in FIG. 5, a sample s10 of a new flow velocity field, which is not expressed with the low-dimensional model before correction, is added at an arbitrary time step t. According to this, the low-dimensional model correcting unit 60 unitizes a component of the sample of the new flow velocity field, and newly adds the unitized component as the orthogonal base bₘ. The low-dimensional model correcting unit 60 corrects the low-dimensional model 12 of the flow velocity field by using the newly added orthogonal base bₘ and a plurality of orthogonal bases b₀ to bₘ₋₁ which already exist. The low-dimensional model 12 of the flow velocity field after correction may be expressed with superposition of the means uₘₑₐₙ of the samples of the flow velocity field, m+1 orthogonal bases b₀ to bₘ which are generated due to a difference between analysis conditions, and components r₀ to rₘ of samples of the respective flow velocity fields.

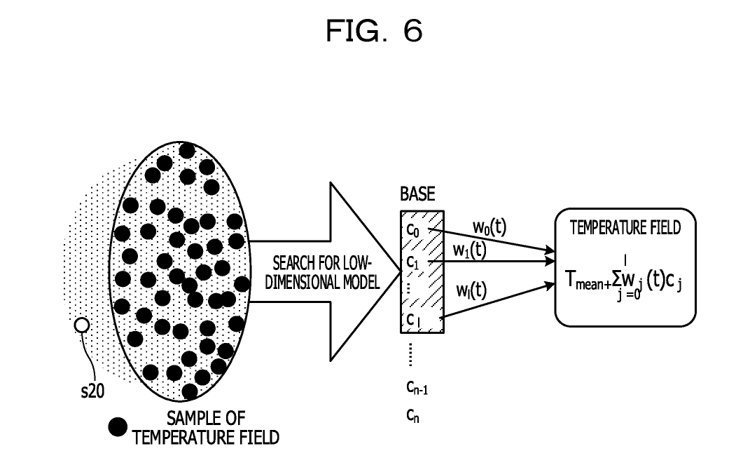

FIG. 6 illustrates an example of a low-dimensional model of a temperature field after correction. As illustrated in FIG. 6, a sample s20 of a new temperature field, which is not expressed with the low-dimensional model before correction, is added at an arbitrary time step t. According to this, the low-dimensional model correcting unit 60 unitizes a component of the sample of the new temperature field, and newly adds the unitized component as an orthogonal base cₗ. The low-dimensional model correcting unit 60 corrects the low-dimensional model 12 of the temperature field by using the newly added orthogonal base cₗ and a plurality of orthogonal bases c₀ to c₁₋₁ which already exist. The low-dimensional model 12 of the temperature field after correction may be expressed with superposition of the mean Tₘₑₐₙ of samples of the temperature field, 1+1 orthogonal bases c₀ to cₗ which are generated due to a difference between analysis conditions, and components w₀ to wₗ of respective samples.

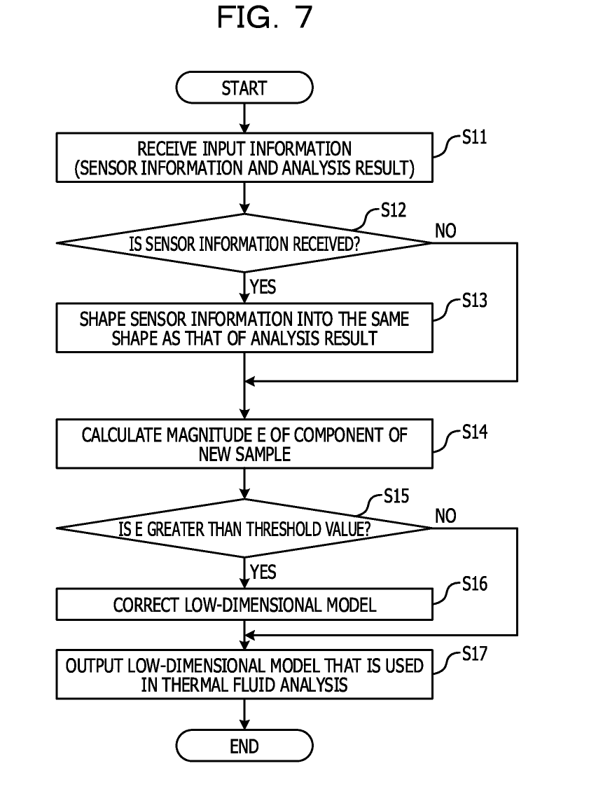

FIG. 7 illustrates an example of a thermal fluid analysis process.

The reception unit 20 waits for reception of input information and receives the input information (operation S11). For example, the sensor information receiving unit 21 receives sensor information of a new sample as the input information. For example, the sensor information may include a position of the new sample, a temperature, a flow velocity distribution, or data of arbitrary combination of the position of the sample, the temperature, and the flow velocity distribution. The analysis result receiving unit 22 receives information, in which the new sample is expressed with an analysis result type, as the input information. For example, the analysis result may include the position of the new sample, the temperature, the flow velocity distribution, or data of arbitrary combination of the position of the new sample, the temperature, and the flow velocity distribution. The model receiving unit 23 receives a shape model and analysis conditions of the new sample as the input information. The sensor information reception unit 21 may receive the sensor information, or may not receive the sensor information as the input information.

The sensor information reception unit 21 determines whether or not the sensor information is received (operation S12). In a case where it is determined that the sensor information is not received (No in operation S12), the sensor information reception unit 21 determines that an analysis result is received, and the process transitions to operation S14.

In a case where it is determined that the sensor information is received (Yes in operation S12), the shaping unit 30 shapes the sensor information in the same type as that of the analysis result (operation S13). For example, the shaping unit 30 calculates a flow velocity value and a temperature at each mesh of a shape model based on the sensor information received by the sensor information receiving unit 21, and reproduces a spatial distribution of an analysis target. The process transitions to operation S14.

In operation S14, based on the analysis result from the sensor information reception unit 21 or information after shaping from the shaping unit 30 as a new sample, the difference calculating unit 40 calculates the magnitude E of a component of a new sample (operation S14). For example, in a case of the flow velocity field, the difference calculating unit 40 calculates a difference between a flow velocity value of the new sample and the mean value of flow velocities of the samples 11 which are included in the intermediate information 13. The difference calculating unit 40 calculates the calculated difference as a component of the new sample. In a case of the temperature field, the difference calculating unit 40 calculates a difference between a temperature value of the new sample and the mean value of temperatures of the samples 11 which are included in the intermediate information 13. The difference calculating unit 40 calculates the calculated difference as a component of the new sample.

The correction and non-correction determining unit 50 determines whether or not the magnitude E of a component of the new sample is greater than the threshold value (operation S15). The threshold value may be set in advance. In a case where it is determined that the magnitude E of the component of the new sample is equal to or less than the threshold value (No in operation S15), the low-dimensional model correcting unit 60 does not perform any process, and the process transitions to operation S17.

In a case where it is determined that the magnitude E of the component of the new sample is greater than the threshold value (Yes in operation S15), the low-dimensional model correcting unit 60 corrects the low-dimensional model 12 (operation S16). For example, the low-dimensional model correcting unit 60 newly adds a vector obtained by unitizing the component of the new sample as a new orthogonal base. The low-dimensional model correcting unit 60 corrects the low-dimensional model 12 by using the newly added orthogonal base and a plurality of orthogonal bases which already exist. The process transitions to operation S17.

In operation S17, the low-dimensional model correcting unit 60 outputs a low-dimensional model that is used in the thermal fluid analysis (operation S17). Then, in the thermal fluid analysis process, the thermal fluid analysis is executed by using the low-dimensional model that is output.

As described above, even when a new sample is added under new analysis conditions, in the thermal fluid analysis process, data processing with respect to the new sample is performed, and thus the low-dimensional model is corrected. According to this, a time taken to recreate the low-dimensional model that is used in the thermal fluid analysis may be shortened.

For example, with respect to a new sample different from the plurality of samples, the information processing device 1 calculates a component of the new sample. In a case where the calculated component of the new sample is greater than the threshold value, the information processing device 1 sets a component obtained by unitizing the component of the new sample as a base, and adds the base to the plurality of bases which already exist. The information processing device 1 corrects the low-dimensional model 12 by using the added base and the plurality of bases which already exist. As described above, even when a new sample is added, the information processing device 1 performs data processing with respect to only the new sample and corrects the low-dimensional model 12, and thus a time taken to recreate the low-dimensional model 12 that is used in the thermal fluid analysis may be shortened.

The information processing device 1 calculates a difference between the new sample and the mean of the plurality of samples which already exist as a component of the new sample. As described above, the information processing device 1 calculates the component of the new sample by using the mean of the plurality of samples which already exist, and thus a base, which is capable of expressing the new sample, may be easily calculated.

With regard to the flow velocity field, the information processing device 1 calculates a difference between a flow velocity value of a new sample and the mean value of the flow velocity values of the plurality of samples which already exist as a component of the flow velocity field of the new sample. As described above, the information processing device 1 calculates the component of the flow velocity field of the new sample by using the mean value of the flow velocity values of the plurality of samples which already exist, and thus a base, which is capable of expressing the flow velocity field of the new sample, may be easily calculated.

With regard to the temperature field, the information processing device 1 calculates a difference between a temperature value of the new sample and the mean value of temperature values of the plurality of samples which already exist as a component of the temperature field of the new sample. As described above, the information processing device 1 calculates the component of the temperature field of the new sample by using the mean value of the temperature values of the plurality of samples which already exist, and thus a base, which is capable of expressing the temperature field of the new sample may be easily calculated.

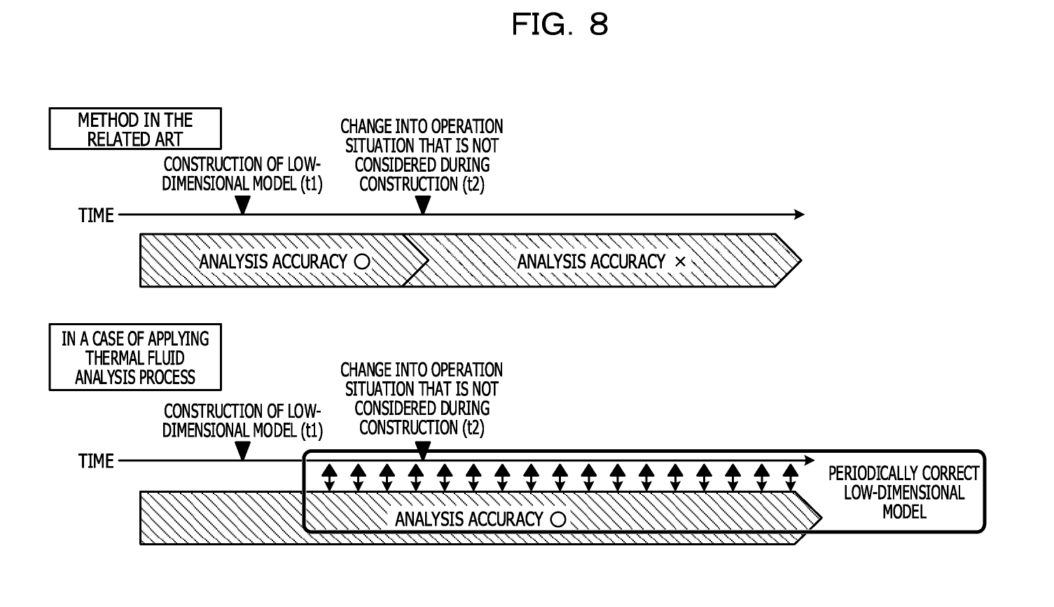

FIG. 8 illustrates an example of thermal analysis of a data center. The above-described thermal fluid analysis process may be applied to the thermal analysis of the data center. As illustrated in FIG. 8, the low-dimensional model 12 may be constructed at a point of time t1. Then, at a point of time t2, the low-dimensional model 12 is changed into an operation situation which is not considered during construction. For example, in another thermal fluid analysis process, the thermal analysis is performed by using the low-dimensional model 12 which does not consider the changed operation situation, and thus analysis accuracy of the thermal analysis may be poor. In addition, the low-dimensional model 12 is created by using a sample relating to the changed operation situation and a sample which already exists, and thus a time may be taken to recreate the low-dimensional model 12. In the above-described thermal fluid analysis process, the low-dimensional model 12 is corrected by using only the sample relating to the changed operation situation, and thus a time taken to recreate the low-dimensional model 12 may be shortened. In addition, the low-dimensional model 12 is periodically corrected based on monitoring data, and thus a temperature may be predicted with good analysis accuracy.

The model receiving unit 23 may receive information relating to a shape model obtained by three-dimensionally modelling an analysis target, and analysis conditions of a new sample. The storage unit 10 may store the information relating to the shape model and the analysis conditions of the new sample in advance.

Each component of the information processing device 1 may not have a configuration that is physically illustrated. For example, the entirety of or parts of the information processing device 1 may be functionally or physically divided or integrated in an arbitrary unit in accordance with various loads, a use situation, and the like. For example, the sensor information receiving unit 21, the analysis result receiving unit 22, and the model receiving unit 23 may be integrated as one unit. The correction and non-correction determining unit 50 and the low-dimensional model correcting unit 60 may be integrated as one unit. The difference calculating unit 40 may be divided into a calculation unit that calculates a difference, and a calculation unit that calculates the magnitude from the difference. The storage unit 10 may be coupled as an external device to the information processing device 1 through a network.

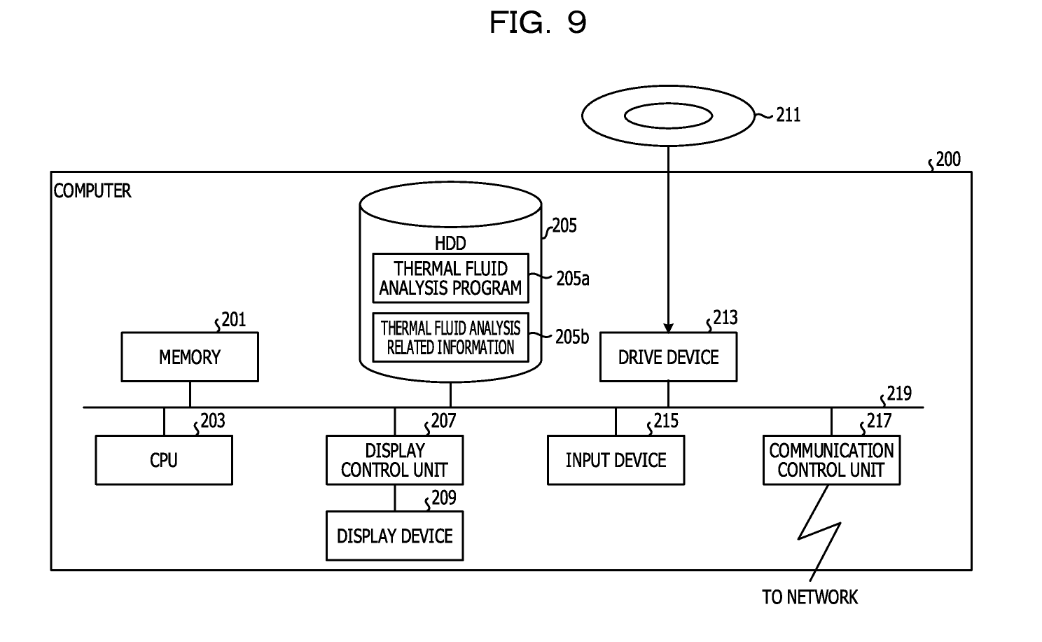

The above-described various processes may be executed by executing a program prepared in advance with a computer such as a personal computer and a workstation. FIG. 9 illustrates an example of a computer. The computer illustrated in FIG. 9 may execute a thermal fluid analysis program, for example, a thermal fluid analysis program realizing the same function as that of the information processing device 1 illustrated in FIG. 2.

As illustrated in FIG. 9, a computer 200 includes a CPU 203 that executes an operation process, an input device 215 that receives an input of data from a user, and a display control unit 207 that controls a display device 209. The computer 200 includes a drive device 213 that reads out a program and the like from a storage medium, and a communication control unit 217 that transmits and receives data to and from another computer through a network. The computer 200 includes a memory 201 that temporarily stores various kinds of information and a HDD 205. The memory 201, the CPU 203, the HDD 205, the display control unit 207, the drive device 213, the input device 215, and the communication control unit 217 are coupled via a bus 219.

The drive device 213 may be a device for a removable disk 211. The HDD 205 stores a thermal fluid analysis program 205a and thermal fluid analysis related information 205b.

The CPU 203 reads out the thermal fluid analysis program 205a, develops the thermal fluid analysis program 205a in the memory 201, and executes the thermal fluid analysis program 205a as a process. The process may correspond to each functional unit of the information processing device 1. For example, the thermal fluid analysis related information 205b may correspond to the sample 11, the low-dimensional model 12, and the intermediate information 13. For example, the removable disk 211 may store various kinds of information such as the thermal fluid analysis program 205a.

The thermal fluid analysis program 205a may be stored in the HDD 205 from the beginning, or may not be stored. For example, a program may be stored in a “portable physical medium” such as a flexible disk (FD), a CD-ROM, a DVD disk, a magneto-optical disc, and an IC card which are inserted into the computer 200. The computer 200 may read out the thermal fluid analysis program 205a from the portable physical media for execution.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

Wat is claimed is:

1. A thermal fluid analysis method, comprising:
calculating, by a computer, a first component of a new first sample different from a plurality of second samples;
setting a second component obtained by unitizing the first component to a first base;
adding the first base to a plurality of second bases of the plurality of second samples when the first component is greater than a threshold value; and
correcting a low-dimensional model that expresses a plurality samples with superposition of a plurality of bases by using the first base and the plurality of second bases.

2. The thermal fluid analysis method according to claim 1,
wherein a difference between the first sample and a mean of the plurality of second samples is calculated as the first component.

3. The thermal fluid analysis method according to claim 1,
wherein with regard to a flow velocity field, a difference between a flow velocity value of the first sample and a mean value of flow velocity values of the plurality of second samples is calculated as a component of a flow velocity field of the first sample.

4. The thermal fluid analysis method according to claim 1,
wherein with regard to a temperature field, a difference between a temperature value of the first sample and a mean value of temperature values of the plurality of second samples is calculated as a component of a temperature field of the first sample.

5. The thermal fluid analysis method according to claim 1,
wherein the first component is undescribed by using the first base to describe the plurality of second samples.

6. An information processing device, comprising:
a CPU; and
a memory that stores a thermal fluid analysis program which is executed by the CPU and uses a low-dimensional model expressing a plurality of samples with superposition of a plurality of bases,
wherein the CPU, based on the thermal fluid analysis program, performs operations of:
calculating a first component of a new first sample different from a plurality of second samples;
setting a second component obtained by unitizing the first component to a first base;
adding the first base to a plurality of second bases of the plurality of second samples when the first component is greater than a threshold value and
correcting the low-dimensional model by using the first base and the plurality of second bases.

7. The information processing device according to claim 6,
wherein a difference between the first sample and a mean of the plurality of second samples is calculated as the first component.

8. The information processing device according to claim 6,
wherein with regard to a flow velocity field, a difference between a flow velocity value of the first sample and a mean value of flow velocity values of the plurality of second samples is calculated as a component of a flow velocity field of the first sample.

9. The information processing device according to claim6,
wherein with regard to a temperature field, a difference between a temperature value of the first sample and a mean value of temperature values of the plurality of second samples is calculated as a component of a temperature field of the first sample.

10. The information processing device according to claim 6,
wherein the first component is undescribed by using the first base to describe the plurality of second samples.

11. A recording medium storing a thermal fluid analysis program executable by a computer, the program allowing the computer to execute operations of:
calculating a first component of a new first sample which is different from a plurality of second samples;
setting a second component obtained by unitizing the first component to a first base;
adding the first base to a plurality of second bases of the plurality of second samples when the first component is greater than a threshold value; and
correcting a low-dimensional model that expresses a plurality samples with superposition of a plurality of bases by using the first base and the plurality of second bases.

12. The recording medium according to claim 11,
wherein a difference between the first sample and a mean of the plurality of second samples is calculated as the first component.

13. The recording medium according to claim 11,
wherein with regard to a flow velocity field, a difference between a flow velocity value of the first sample and a mean value of flow velocity values of the plurality of second samples is calculated as a component of a flow velocity field of the first sample.

14. The recording medium according to claim 11,
wherein with regard to a temperature field, a difference between a temperature value of the first sample and a mean value of temperature values of the plurality of second samples is calculated as a component of a temperature field of the first sample.

15. The recording medium according to claim 11,
wherein the first component is undescribed by using the first base to describe the plurality of second samples.
